(19) United States
(12) Patent Application Publication
(10) Pub. No.: US 2025/0317218 A1
(43) Pub. Date: Oct. 9, 2025

(54) HYBRID CLASSICAL-QUANTUM TRANSMISSION FOR EAVESDROPPER DETECTION OVER CLASSICAL CHANNELS

(71) Applicant: Cisco Technology, Inc., San Jose, CA (US)

(72) Inventors: Eneet Kaur, Somerville, MA (US); Stephen DiAdamo, Munich (DE); Charles E. Fleming, Oxford, MS (US); Michael John Kilzer, Los Angeles, CA (US); Mohammad Saidur Rahman, Los Angeles, CA (US); Jiapeng Zhao, Kenmore, WA (US)

(21) Appl. No.: 18/629,095

(22) Filed: Apr. 8, 2024

(51) Int. Cl. H04B 10/85; H04B 10/70; H04J 14/00; H04J 14/02; H04J 14/08

(52) U.S. Cl. CPC H04B 10/85; H04B 10/70; H04J 14/0307; H04J 14/05; H04J 14/08

(57) ABSTRACT

An embodiment mixes classical and quantum signals in the same transmission such that an eavesdropper can be detected using the quantum signals while maintaining high classical transmission rates. The embodiment uses security enhancement from quantum signals while maintaining the high data rates of classical communication. The eavesdropper introduces noise when trying to collect information on the physical layer. This noise can be observed by monitoring the quantum signals.

### TECHNICAL FIELD

The present disclosure relates to communication systems.

### BACKGROUND

There is a necessity for data to be transferred securely over optical fibers. Physical layer security is achieved by monitoring fibers using quantum signals. Classical message transmission is susceptible to intercept and resend attacks that can go undetected since classical information can be perfectly copied. There is another threat of store now and decrypt later attack. An approach for the attack by an eavesdropper is to use directional couplers to tap the optical fibers. Directional couplers are passive devices that split the light signal traveling through an optical fiber into two or more paths. Since the classical signal can be perfectly copied and amplified, this tapping attack will not be detected by the legitimate users. Quantum transmission, on the other hand, offers inherent security features due to the principles of quantum mechanics, notably the no-cloning theorem, which states that quantum information cannot be perfectly copied without altering the original state. Therefore, the quantum signal is secure against intercept and resend, and store now and decrypt later attacks. However, quantum information can be transmitted at a limited rate which is not sufficient to fulfill the data transmission requirement for modern communication.

### BRIEF DESCRIPTION OF THE DRAWINGS

FIG. 1 is a block diagram of an example communication environment in which eavesdropper detection may be implemented, according to an example embodiment.

FIG. 2 illustrates a block diagram of network nodes implementing eavesdropper detection based on time division multiplexing of quantum and classical signals, according to an example embodiment.

FIG. 3 illustrates a flowchart of a method for eavesdropper detection based on time division multiplexing of quantum and classical signals, according to an example embodiment.

FIG. 4 illustrates a block diagram of network nodes implementing eavesdropper detection based on wavelength division multiplexing of quantum and classical signals, according to an example embodiment.

FIG. 5 illustrates a flowchart of a method for eavesdropper detection based on wavelength division multiplexing of quantum and classical signals, according to an example embodiment.

FIG. 6 illustrates a block diagram of network nodes implementing eavesdropper detection based on space division multiplexing of quantum and classical signals, according to an example embodiment.

FIG. 7 illustrates a flowchart of a method for eavesdropper detection based on space division multiplexing of quantum and classical signals, according to an example embodiment.

FIG. 8 illustrates a flowchart of a generalized method for eavesdropper detection, according to an example embodiment.

FIG. 9 illustrates a hardware block diagram of a computing device configured to perform functions associated with operations discussed herein, according to an example embodiment.

### DESCRIPTION OF EXAMPLE EMBODIMENTS

### Overview

An embodiment mixes classical and quantum signals in the same transmission such that an eavesdropper can be detected using the quantum signals while maintaining high classical transmission rates. The embodiment uses security enhancement from quantum signals while maintaining the high data rates of classical communication. The eavesdropper introduces noise when trying to collect information on the physical layer. This noise can be observed by monitoring the quantum signals.

### Example Embodiments

An embodiment mixes classical and quantum signals in the same transmission such that an eavesdropper can be detected using the quantum signals while maintaining high classical transmission rates. The embodiment uses security enhancement from quantum signals while maintaining the high data rates of classical communication. The eavesdropper introduces noise when trying to collect information on the physical layer. This noise can be observed by monitoring the quantum signals.

To prevent the eavesdropper from being able to pick out quantum signals undisturbed from the mixed signal, the communicating parties randomly mix the quantum and classical signal types together. The eavesdropper's task of picking out the classical parts from the quantum parts is very difficult. Accordingly, the quantum and classical signals are multiplexed together such that the eavesdropper cannot demultiplex the signals while the true receiver can demultiplex the signals based on the pre-shared randomness.

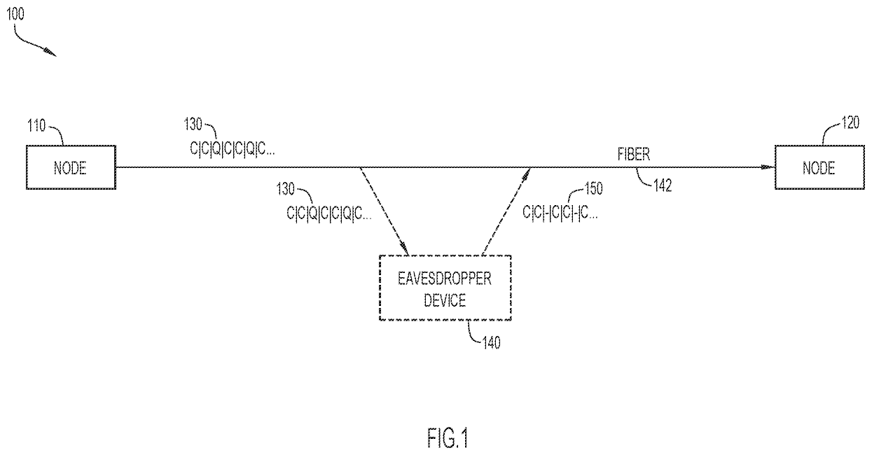

FIG. 1 illustrates an example communication environment 100 in which eavesdropper detection may be implemented, according to an example embodiment. Initially, communication environment 100 includes network nodes 110, 120. By way of example, network node 110 may serve as a sending or transmitting node for communication over fiber 142 or other network channel, while network node 120 may serve as a receiving node for the communication. However, the communication may occur between any network nodes in substantially the same manner described below. Further, a network node may perform, and include components for, the transmitting and/or receiving operations or functions described below. For example, a network node may perform transmitting operations, receiving operations, or both transmitting and receiving operations.

Sending node 110 sends mixed data signal 130 including a mix of one or more classical data signals (e.g., classical digital bits, etc.) representing data to be transmitted and one or more quantum signals (e.g., classic portions are indicated by ‘C’ and quantum portions are indicated by ‘Q’ as shown in FIG. 1) to receiving node 120. The classical and quantum signals are combined or multiplexed (e.g., time division multiplexing, wavelength division multiplexing, space division multiplexing, etc.) by a multiplexing or other switching device based on a pre-shared random sequence as described below. Sending node 110 and receiving node 120 share the same randomness source which allow them to synchronize the encoding/decoding.

An eavesdropper may intercept and resend mixed data signal 130 via an eavesdropper device 140. By randomizing the location of the quantum signals in mixed data signal 130 based on the pre-shared randomness, it is virtually impossible for the eavesdropper to measure just the classical signals representing the data. Accordingly, the eavesdropper measures the quantum signals which affect their state. Eavesdropper device 140 may resend mixed data signal 130 in the form of mixed data signal 150 to receiving node 120 with the quantum information disturbed based on the measurement (e.g., the quantum components ‘—’ indicate disturbed quantum states as viewed in FIG. 1). Receiving node 120, knowing the locations of the quantum signals based on the pre-shared randomness, directs the quantum parts of mixed data signal 150 to a quantum receiver or detector of the receiving node. When the error rate of detection is too high (due to the disturbed quantum states), this indicates the presence of the eavesdropper and appropriate action may be performed (e.g., discarding mixed data signal 150, re-transmitting a new mixed data signal 130, etc.).

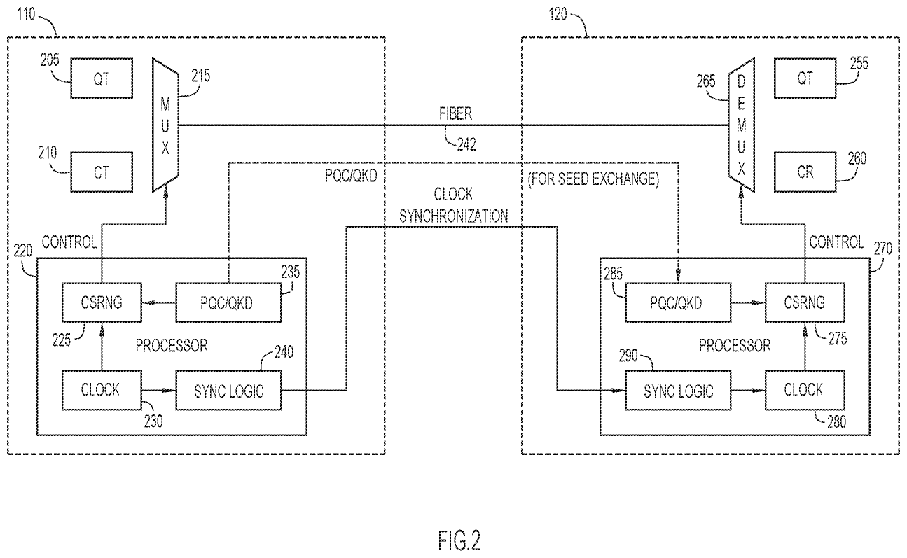

With continued reference to FIG. 1, FIG. 2 illustrates a block diagram of network nodes implementing eavesdropper detection based on time division multiplexing of quantum and classical signals, according to an example embodiment. In an embodiment, the classical data signal representing the data and the quantum signals can be combined or multiplexed using time division multiplexing. By way of example, network node 110 may serve as a sending or transmitting node for communication of data over fiber 242 or other network channel, while network node 120 may serve as a receiving node for the communication. However, the communication may occur between any network nodes in substantially the same manner described below. Sending node 110 and receiving node 120 share a randomness source which allows them to synchronize the encoding/decoding. In order to synchronize the randomness between sending node 110 and receiving node 120, they can securely share a seed. Using a cryptographically secure pseudo-random number generator, they can produce a high rate of correlated random locations to place the quantum signals. By randomizing the location of the quantum signals based on the output from the pseudo-random number generator, it makes it virtually impossible for an eavesdropper to measure just the classical signal representing the data. Accordingly, the eavesdropper measures the quantum signals which affect their state.

Since receiving node 120 shares the same seed with the sending node 110, receiving node 120, knowing the time locations of the quantum signals, directs the quantum parts of a received time division multiplexed signal to a quantum receiver or detector based on the random number. When the error rate of detection is too high (due to the disturbed quantum states), this indicates the presence of the eavesdropper and appropriate action may be performed (e.g., discarding the data signal, re-transmitting a new time division multiplexed signal, etc.).

Initially, sending node 110 includes a quantum transmitter 205, a classical transmitter 210, a multiplexer 215, and a processor 220. These may be within a network interface, and may be implemented by any conventional or other components for performing operations of a present embodiment. Receiving node 120 includes a quantum receiver 255, a classical receiver 260, a de-multiplexer 265, and a processor 270. These may be in a network interface, and may be implemented by any conventional or other components for performing operations of a present embodiment.

Processor 220 of sending node 110 includes a cryptographically secure random number generator (CSRNG) 225, a clock 230, an exchange module 235, and synchronization logic 240. These may be implemented by any conventional or other components for performing operations of a present embodiment. Processor 270 of receiving node 120 includes a cryptographically secure random number generator (CSRNG) 275, a clock 280, an exchange module 285, and synchronization logic 290. These may be implemented by any conventional or other components for performing operations of a present embodiment.

Initially, sending node 110 desires to transmit a classical data signal (e.g., digital bits representing data to be transmitted) to receiving node 120. A random seed is used to generate a random sequence for mixing one or more quantum signals into the classical data signal via time division multiplexing to produce a mixed or hybrid data signal (e.g., of classical and quantum signals, etc.). The random seed may be generated by exchange module 235 of sending node 110 via any conventional or other techniques, and pre-shared by exchange module 235 of the sending node and exchange module 285 of receiving node 120 via any conventional or other protocols (e.g., quantum key distribution (QKD), post quantum cryptography (PQC), etc.). Synchronization logic 240 of sending node 110 and synchronization logic 290 of receiving node 120 synchronize clock 230 of the sending node with clock 280 of the receiving node. Synchronization logic 240, 290 of the sending and receiving nodes are coupled to respective clocks 230, 280, and may use any conventional or other techniques to synchronize clocks 230, 280. The shared random seed and synchronized clocks enable the sending and receiving nodes to generate the same random sequence for sending and receiving the mixed data signal in a manner to detect eavesdroppers.

Cryptographically secure random number generator 225 of sending node 110 receives the random seed from exchange module 235, and uses the random seed to generate a random sequence including a random bit string under control of signals from clock 230. The random bit string is used to mix quantum signals into the classical data signal to produce the mixed data signal for transmission. For example, the bits of the random bit string may correspond to time intervals of the mixed data signal (e.g., time slots of a time division multiplexing frame, etc.). A zero bit of the random bit string may trigger insertion of classical signals (or the data from the classical data signal) at the corresponding time interval of the mixed data signal (e.g., time slot of a time division multiplexing frame, etc.), while a one bit of the random bit string may trigger insertion of quantum signals at the corresponding time interval of the mixed data signal (e.g., time slot of a time division multiplexing frame, etc.). However, the values of the bit string may be associated with classical and quantum signals in any fashion (e.g., a one (or zero) bit may trigger insertion of classical signals, while a zero (or one) bit may trigger insertion of quantum signals, etc.).

Processor 220 of sending node 110 is coupled to multiplexer 215 (e.g., or other switching device, etc.). The multiplexer selects quantum signals from quantum transmitter 205 or classical signals of the data signal from classical transmitter 210 based on control signals from processor 220 to mix the quantum signals with the classical data signal to produce the mixed data signal for transmission. The random bit string produced by cryptographically secure random number generator 225 is provided to multiplexer 215 at appropriate times based on signals from clock 230, and serves as controls to select the classical and quantum signals for corresponding time intervals of the mixed data signal (e.g., time slots of a time division multiplexing frame, etc.) based on the bit values of the random bit string. The resulting mixed data signal is sent from sending node 110 to receiving node 120. In other words, sending node 110 actively switches (via multiplexer 215) between quantum transmitter 205 and classical transmitter 210 for sending the mixed data signal over fiber 242 to receiving node 120 based on the random bit string. The quantum signals and classical signals of the mixed data signal are time division multiplexed.

Cryptographically secure random number generator 275 of receiving node 120 receives the random seed from exchange module 285, and uses the random seed to generate the same random sequence including the random bit string used for transmission of the mixed data signal under control of signals from clock 280. The random bit string is used to retrieve the classical and quantum signals from the mixed data signal. For example, the bits of the random bit string may correspond to time intervals of the mixed data signal (e.g., time slots a time division multiplexing frame, etc.). A zero bit of the random bit string may indicate classical signals (or data of the classical data signal) at the corresponding time interval of the mixed data signal (e.g., time slot of a time division multiplexing frame, etc.), while a one bit of the random bit string may indicate a quantum signal at the corresponding time interval of the mixed data signal (e.g., time slot of a time division multiplexing frame, etc.). However, the values of the bit string may be associated with classical and quantum signals in any fashion (e.g., a one (or zero) bit may indicate classical signals (or data of the classical data signal), while a zero (or one) bit may indicate quantum signals, etc.).

Processor 270 of receiving node 120 is coupled to de-multiplexer 265 (e.g., or other switching device, etc.). The de-multiplexer directs or routes signals from the mixed data signal to quantum receiver 255 or classical receiver 260 based on control signals from processor 270 to process the mixed data signal and determine a presence of an eavesdropper. The random bit string produced by cryptographically secure random number generator 275 is provided to de-multiplexer 265 at appropriate times based on signals from clock 280, and serves as controls to direct the classical and quantum signals for corresponding time intervals of the mixed data signal (e.g., time slots of a time division multiplexing frame, etc.) to quantum receiver 255 or classical receiver 260 based on the bit values of the random bit string (e.g., indicating classical or quantum signals).

In this case, receiving node 120 knows the locations of the quantum signal in the mixed data signal based on the random bit string, and actively switches (via de-multiplexer 265) between directing portions of the mixed data signal to quantum receiver 255 and classical receiver 260. By randomizing the location of the quantum signals, it makes it virtually impossible for an eavesdropper to measure just the classical signal representing the data. Accordingly, the eavesdropper measures the quantum signals which affect their state. When the error rate of detection is too high (due to the disturbed quantum states), this indicates the presence of the eavesdropper and receiving node 120 may perform appropriate action (e.g., discard the mixed data signal, send communication to the sending node to re-transmit a new mixed data signal (e.g., using a new random bit string, etc.), etc.).

Thus, a synchronized cryptographically secure random number generator (CSRNG) with a dynamic switching device (or multiplexer) are used on both the transmitter and receiver side. The switching device (or multiplexer) mixes or routes the signal based on the random number sequence from CSRNG.

In addition, updating of the (random seed for the) cryptographically secure random number generators (CSRNGs) in the sending and receiving nodes are synchronized. The CSRNGs are updated concurrently to maintain the correct configuration of quantum and classical signal time divisions. The synchronization may use any conventional or other protocols (e.g., Precision Time Protocol, Synchronous Ethernet, etc.). The time or time intervals at which the CSRNGs are concurrently updated (with new random seeds) may be randomized via the use of another CSRNG or by processing the output of the same CSRNG. This would introduce further randomization into the time division configuration, making it harder for an eavesdropper to listen if they were somehow taking advantage of the periodic nature of configuration changes.

In order to accurately measure loss in fiber 242 and excess noise, a high number of quantum signals is used (e.g., at least the same amount as the classical signals, etc.). In conventional techniques, due to a passive switch, almost half of the quantum signals are abandoned or sent to the classical receiver, while at the same time, half of the classical signals are also wasted on a quantum receiver, thereby leading to lower transmission rates. With the use of a cryptographically secure random number generator (CSRNG) and an active switching device (or multiplexer), a better estimate of channel parameters is attained since none of the quantum signals are sent to the classical receiver. Meanwhile, the active switching based on random string can avoid the possible blinding of quantum receivers from the classical signal. This switching device dynamically selects between quantum and classical receivers based on the pre-determined (or shared random) pattern of quantum signal placement, thereby enhancing classical communication capacity.

Receiving node 120 separates the classical signal from the quantum signal to measure the signals separately, but an eavesdropper should not be able to do the same. The eavesdropper goal is to measure the classical signal while allowing the quantum signal to flow through. When a time division multiplex is used to insert quantum signals, the receiver switches the quantum and classical information fast enough so as to not send any classical signals to a quantum detector which can damage (or blind) the quantum detector. A consequence of this is that the sending node and receiving node coordinate the transmission such that they know at which time index the classical and quantum signals reside. In other words, the sending and receiving nodes share randomness. There may be an attack that allows the eavesdropper to learn the randomness pattern. However, the shared random seed may be refreshed often to overcome the attack. Once the secure communication is established between the transmitter and receiver, the shared random seed may be refreshed using the established secure link to overcome future attacks.

In addition, the frequency of transmission can be randomized in substantially the same manner described herein, provided there are enough frequencies such that an eavesdropper cannot split them all.

Since sending single photons is generally difficult, an embodiment may use decoy states to address this issue. For example, in a decoy state technique, qubits are transmitted at randomly selected intensity levels (e.g., for a signal state and decoy states). This provides varying photon number statistics. The intensity levels are disclosed after transmission. Since a successful attack requires maintaining a bit error rate, this cannot be achieved with multiple photon number statistics. Accordingly, an attack may be detected by monitoring bit error rates associated with each intensity level. In the embodiment, the coherent state of various intensities may be sent, and later checked to determine a presence of an attack. In this case, the sending and receiving node measure various statistics of the decoy state. When the observed statistics do not agree with expected statistics, the presence of the eavesdropper or a malfunction in the device may be determined.

Photon number splitting attacks may occur on the mixed signal. In this case, the quantum signal will not get absorbed, but this attack would be detected using decoy state formalism. As an example, on-off keying may be used as the classical encoding. An eavesdropper attack may split the signal and give the eavesdropper knowledge of the encoding whenever a photon is detected in the split signal. However, in the case of decoy states, the splitting attack can be detected by decoy state analysis. This may also be applied for quadrature phase-shift keying (QPSK) encoding.

Mixing classical and quantum signals into one transmission may cause Raman noise effects. This can be bypassed to a certain extent by wavelength division multiplexing (WDM) or space division multiplexing (SDM) described below.

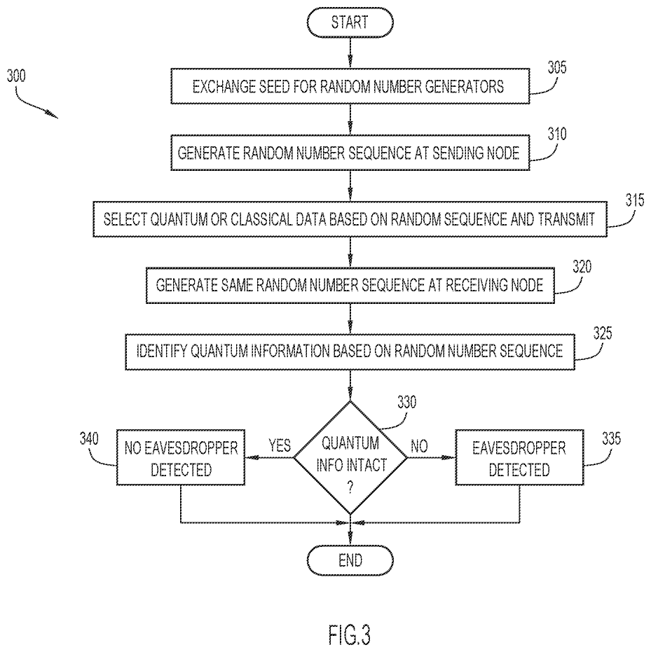

With continued reference to FIGS. 1-2, FIG. 3 illustrates a flowchart of a method 300 for eavesdropper detection based on time division multiplexing of quantum and classical signals, according to an example embodiment. By way of example, network node 110 may serve as a sending or transmitting node for communication of data over fiber 242 or other network channel, while network node 120 may serve as a receiving node for the communication. However, the communication may occur between any network nodes in substantially the same manner described below.

Initially, sending node 110 desires to transmit a classical data signal (e.g., digital bits representing the data to be transmitted, etc.) to receiving node 120. A random seed is used to generate a random sequence for mixing one or more quantum signals into the classical data signal via time division multiplexing to produce a mixed or hybrid data signal (e.g., of classical and quantum signals, etc.). The random seed is generated by sending node 110, and pre-shared with receiving node 120 via any conventional or other protocols (e.g., quantum key distribution (QKD), post quantum cryptography (PQC), etc.) at operation 305 in substantially the same manner described above. Synchronization logic 240 of sending node 110 and synchronization logic 290 of receiving node 120 synchronize clock 230 of the sending node with clock 280 of the receiving node. In addition, clocks 230, 280 of the sending and receiving nodes are synchronized, where the shared random seed and synchronized clocks enable the sending and receiving nodes to generate the same random sequence for sending and receiving the mixed data signal in a manner to detect eavesdroppers.

Sending node 110 uses the random seed to generate a random sequence (or random bit string) at operation 310 in substantially the same manner described above. The random bit string is used to mix quantum signals into the classical data signal to produce the mixed data signal for transmission. For example, the bits of the random bit string may correspond to time intervals of the mixed data signal (e.g., time slots of a time division multiplexing frame, etc.). A zero bit of the random bit string may trigger insertion of classical signals (or the data from the classical data signal) at the corresponding time interval of the mixed data signal (e.g., time slot of a time division multiplexing frame, etc.), while a one bit of the random bit string may trigger insertion of quantum signals at the corresponding time interval of the mixed data signal (e.g., time slot of a time division multiplexing frame, etc.). However, the values of the bit string may be associated with classical and quantum signals in any fashion (e.g., a one (or zero) bit may trigger insertion of classical signals, while a zero (or one) bit may trigger insertion of quantum signals, etc.).

Multiplexer 215 of sending node 110 selects quantum signals from quantum transmitter 205 or classical signals of the data signal from classical transmitter 210 based on the bit values of the random bit string at operation 315 in substantially the same manner described above. The resulting mixed data signal is sent from sending node 110 to receiving node 120. In other words, sending node 110 actively switches (via multiplexer 215) between quantum transmitter 205 and classical transmitter 210 for sending the mixed data signal over fiber 242 to receiving node 120. The quantum signals and classical signals of the mixed data signal are time division multiplexed.

Receiving node 120 uses the shared random seed to generate the same random sequence (or random bit string) used for transmission of the mixed data signal at operation 320 in substantially the same manner described above. The random bit string is used to retrieve the classical and quantum signals from the mixed data signal. For example, the bits of the random bit string may correspond to time intervals of the mixed data signal (e.g., time slots of a time division multiplexing frame, etc.). A zero bit of the random bit string may indicate classical signals (or data of the classical data signal) at the corresponding time interval of the mixed data signal (e.g., time slot of a time division multiplexing frame, etc.), while a one bit of the random bit string may indicate a quantum signal at the corresponding time interval of the mixed data signal (e.g., time slot of a time division multiplexing frame, etc.). However, the values of the bit string may be associated with classical and quantum signals in any fashion (e.g., a one (or zero) bit may indicate classical signals (or data of the classical data signal), while a zero (or one) bit may indicate quantum signals, etc.).

De-multiplexer 265 of receiving node 120 directs or routes signals from the mixed data signal to quantum receiver 255 or classical receiver 260 based on bit values of the random bit string (e.g., indicating classical or quantum signals) at operation 325 in substantially the same manner described above. In this case, receiving node 120 knows the locations of the quantum signals in the mixed data signal based on the random bit string, and actively switches (via de-multiplexer 265) between directing portions of the mixed data signal to quantum receiver 255 and classical receiver 260. By randomizing the location of the quantum signals, it makes it virtually impossible for an eavesdropper to measure just the classical signal. Accordingly, the eavesdropper measures the quantum signals which affect their state.

The quantum signals are analyzed, and when an error rate of detection is too high (e.g., exceeds a threshold due to the disturbed quantum states produced by an eavesdropper) as determined at operation 330, this indicates the presence of the eavesdropper at operation 335. Receiving node 120 may perform an appropriate action in response to detection of the eavesdropper (e.g., discard the mixed data signal, send communication to the sending node to re-transmit a new mixed data signal (e.g., using a new random bit string, etc.), etc.).

When the error rate of detection is acceptable (e.g., at or below the threshold) as determined at operation 330, this indicates the absence of the eavesdropper (e.g., valid or secure data, etc.) at operation 340. Receiving node 120 may perform an appropriate action in response to the valid or secure data (e.g., process the data, forward the data, etc.).

In an embodiment, a randomization in wavelength may be used to hide quantum signals within the mixed data signal. In other words, the quantum signals and classical data signal (e.g., digital bits representing data to be transmitted, etc.) are wavelength division multiplexed to produce the mixed data signal. In this case, a transmitter of a sending node may include a frequency comb that emits single photons in different wavelengths. A quantum receiver at a receiving node includes a single photon detector and an interferometer. A classical receiver may employ conventional or other homodyne detection. Channel statistics are calculated by observing loss experienced by the single photons. The wavelengths of quantum and classical signals are chosen based on a random sequence (e.g., random numbers, etc.) from synchronized cryptographically secure random number generators (CSRNGs).

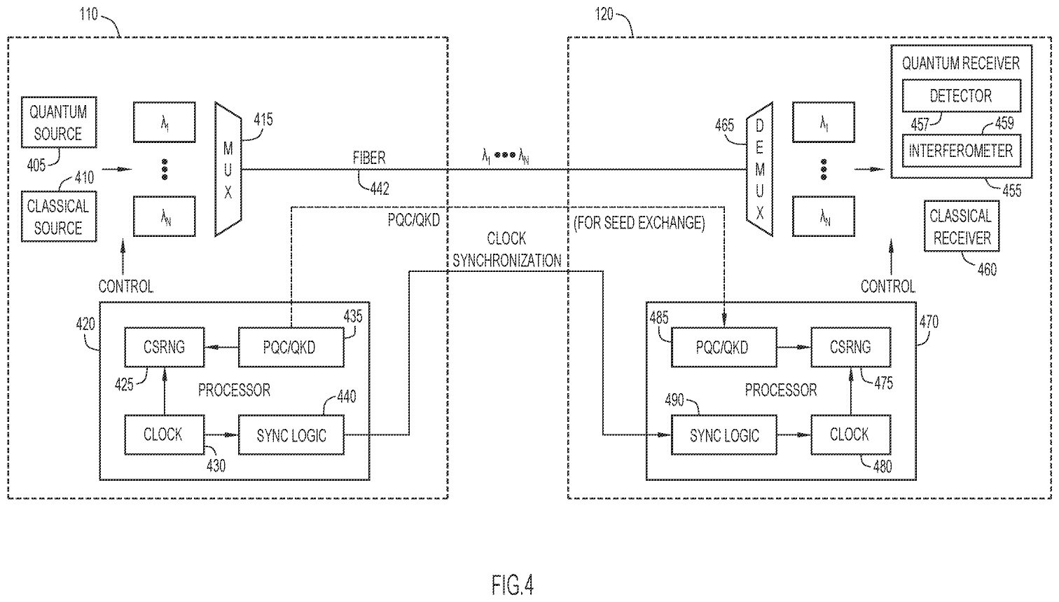

With continued reference to FIG. 1, FIG. 4 illustrates a block diagram of network nodes implementing eavesdropper detection based on wavelength division multiplexing of quantum and classical signals, according to an example embodiment. In an embodiment, the classical and quantum signals can be multiplexed using wavelength division multiplexing. By way of example, network node 110 may serve as a sending or transmitting node for communication of data over fiber 442 or other network channel, while network node 120 may serve as a receiving node for the communication. However, the communication may occur between any network nodes in substantially the same manner described below. Sending node 110 and receiving node 120 share a randomness source which allow them to synchronize the encoding/decoding. In order to synchronize the randomness between sending node 110 and receiving node 120, they can securely share a seed. Using a cryptographically secured pseudo-random number generator, they can produce a high rate of correlated random locations (or wavelengths) to place the quantum signals. By randomizing the location of the quantum signals, it makes it virtually impossible for an eavesdropper to measure just the classical signal. Accordingly, the eavesdropper measures the quantum signals which affect their state.

Receiving node 120, knowing the wavelengths of the quantum signals, directs the quantum parts of a received wavelength division multiplexed signal to a quantum receiver or detector. When the error rate of detection is too high (due to the disturbed quantum states), this indicates the presence of the eavesdropper and appropriate action may be performed (e.g., discarding the data signal, re-transmitting a new mixed data signal, etc.).

Initially, sending node 110 includes a quantum source 405, a classical source 410, a wavelength division multiplexer 415 (e.g., a coarse wavelength division multiplexer (CWDM), normal wavelength division multiplexer (WDM), dense wavelength division multiplexer, etc.), and a processor 420. These may be in a network interface, and may be implemented by any conventional or other components for performing operations of a present embodiment. Receiving node 120 includes a quantum receiver 455, a classical receiver 460, a wavelength division de-multiplexer 465 (e.g., a coarse wavelength division de-multiplexer (CWDM), normal wavelength division de-multiplexer (WDM), dense wavelength division de-multiplexer (DWDM), etc.), and a processor 470. These may be in a network interface, and may be implemented by any conventional or other components for performing operations of a present embodiment.

Processor 420 of sending node 110 includes a cryptographically secure random number generator (CSRNG) 425, a clock 430, an exchange module 435, and synchronization logic 440. These may be implemented by any conventional or other components for performing operations of a present embodiment, and may be substantially similar to the corresponding components described above (FIG. 2). Processor 470 of receiving node 120 includes a cryptographically secure random number generator (CSRNG) 475, a clock 480, an exchange module 485, and synchronization logic 490. These may be implemented by any conventional or other components for performing operations of a present embodiment, and may be substantially similar to the corresponding components described above (FIG. 2).

Initially, sending node 110 desires to transmit a classical data signal (e.g., digital bits representing the data to be transmitted, etc.) to receiving node 120. A random seed is used to generate a random sequence for mixing quantum signals and the data signal via wavelength division multiplexing to produce a mixed or hybrid data signal (e.g., of classical and quantum signals, etc.). The random seed may be generated by exchange module 435 of sending node 110 via any conventional or other techniques, and pre-shared by exchange module 435 of the sending node and exchange module 485 of receiving node 120 via any conventional or other protocols (e.g., quantum key distribution (QKD), post quantum cryptography (PQC), etc.) in substantially the same manner described above. Synchronization logic 440 of sending node 110 and synchronization logic 490 of receiving node 120 synchronize clock 430 of the sending node with clock 480 of the receiving node. Synchronization logic 440, 490 of the sending and receiving nodes are coupled to respective clocks 430, 480, and may use any conventional or other techniques to synchronize clocks 430, 480 in substantially the same manner described above. The shared random seed and synchronized clocks enable the sending and receiving nodes to generate the same random sequence for sending and receiving the mixed data signal in a manner to detect eavesdroppers.

Cryptographically secure random number generator 425 of sending node 110 receives the random seed from exchange module 435, and uses the random seed to generate a random sequence including random numbers under control of signals from clock 430. The random numbers are used to mix quantum signals and the classical data signal to produce the mixed data signal for transmission. For example, the random numbers may correspond to wavelengths for the mixed data signal (e.g., wavelengths for wavelength division multiplexing, etc.). By way of example, the random numbers may be within a numeric range with numbers of the range mapped to corresponding wavelengths (e.g., the wavelength may be a multiple of the random number, may be associated with the random number by a listing or mapping, etc.).

Processor 420 of sending node 110 is coupled to quantum source 405 and classical source 410. Quantum source 405 may include any conventional or other frequency comb that emits single photons in different wavelengths. The quantum source receives random numbers (or wavelengths) from processor 420 for producing quantum signals. The processor may determine a quantity of random numbers to send to the quantum transmitter (or amount of quantum signals in the mixed data signal) based on various criteria (e.g., security level, amount of classical data, etc.). Classical source 410 receives random numbers (or wavelengths) from processor 420 for producing classical data signals. The random numbers produced by cryptographically secure random number generator 425 are provided at appropriate times based on signals from clock 430, and serve as controls to indicate the wavelengths for classical and quantum signals for the mixed data signal. The quantum and classical signals of the various wavelengths are provided to multiplexer 415 (e.g., or other switching device, etc.) that combines the individual wavelengths to form the mixed data signal. The mixed data signal is sent from sending node 110 to receiving node 120. In other words, sending node 110 randomly selects wavelengths for quantum source 405 and classical source 410 for sending the mixed data signal over fiber 442 to receiving node 120. The quantum signals and classical signals of the mixed data signal are wavelength division multiplexed.

Cryptographically secure random number generator 475 of receiving node 120 receives the random seed from exchange module 485, and uses the random seed to generate the same random sequence including random numbers (or wavelengths) used for transmission of the mixed data signal under control of signals from clock 480. The random numbers indicate the wavelengths for the classical and quantum signals in order to retrieve those signals from the mixed data signal and direct them to the appropriate (quantum or classical) receiver.

De-multiplexer 465 (e.g., or other switching device, etc.) de-multiplexes the mixed data signal into individual wavelengths that are directed to quantum receiver 455 or classical receiver 460 based on the random numbers (or wavelengths) from processor 470 to process the mixed data signal and determine a presence of an eavesdropper. The random numbers produced by cryptographically secure random number generator 475 are provided at appropriate times based on signals from clock 480, and serve as controls to identify and direct the classical and quantum signals of the mixed data signal (e.g., at the various wavelengths, etc.) to quantum receiver 455 or classical receiver 460 based on the random number (or wavelength) (e.g., associated with quantum or classical signals).

In this case, receiving node 120 knows the wavelengths of the quantum signals in the mixed data signal based on the random numbers, and actively directs portions of the mixed data signal to quantum receiver 455 and classical receiver 460. By randomizing the wavelengths of the quantum signals, it makes it virtually impossible for an eavesdropper to measure just the classical signal. Accordingly, the eavesdropper measures the quantum signals which affect their state.

Quantum receiver 455 may include any conventional or other photon detector 457 and interferometer 459. These devices detect and calculate channel statistics by observing loss experienced by single photons. When the error rate (or loss) is too high (due to the disturbed quantum states), this indicates the presence of the eavesdropper and the receiving node may perform appropriate action (e.g., discard the mixed data signal, send communication to the sending node to re-transmit a new mixed data signal (e.g., using a new random sequence of wavelengths, etc.), etc.).

By using synchronized cryptographically secure random number generators (CSRNGs), the quantum signals may be hidden by randomly selecting the encoding wavelength, and a single photon detector may be used for the quantum receiver. The implementation of a wavelength tunable quantum source may use frequency-bin qudits from a quantum frequency comb. However, the photon rate is usually lower and the detection may involve a phase stabilized interferometer.

Further, Raman noise may be induced by strong classical beams. Several conventional or other approaches may be employed to reduce the noise, but eventually the classical signal will have a limited power. To keep the noise photon counts to a lower level, the signal-to-noise ratio (SNR) in the classical signal may be sacrificed.

Wavelength multiplexing has substantially the same advantages described above (for time division multiplexing based on use of random sequences), and also provides additional advantages. For example, since the signal is not time division multiplexed, no bandwidth is wasted for each channel. This approach is also naturally compatible with widely used wavelength division multiplexing infrastructure in the optical telecommunication industry, which leads to less cost to be implemented. This helps with accurately calculating the loss and excess noise. After the accurate estimation of loss and excess noise, the level of security can be adjusted by adopting different amounts of quantum channels in the system.

In addition, updating of the (random seed of the) cryptographically secure random number generators (CSRNGs) in the sending and receiving nodes may be synchronized. The CSRNGs are updated concurrently to maintain the correct configuration of quantum and classical signal wavelengths. The synchronization may use any conventional or other protocols (e.g., Precision Time Protocol, Synchronous Ethernet, etc.). The time or time intervals at which the CSRNGs are concurrently updated may be randomized via the use of another CSRNG, or by processing the output of the same CSRNG. This would introduce further randomization into the wavelength configuration, making it harder for an eavesdropper to listen if they were somehow taking advantage of the periodic nature of the wavelength configuration changes.

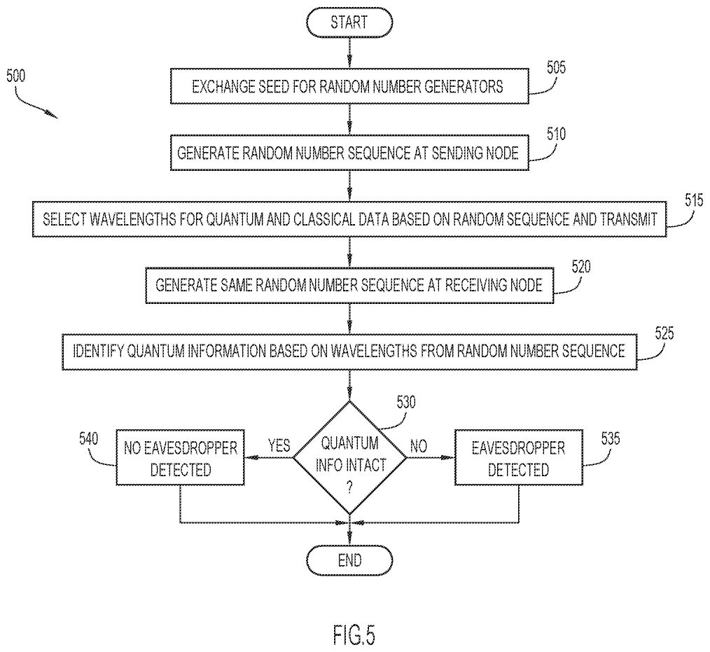

With continued reference to FIGS. 1 and 4, FIG. 5 illustrates a flowchart of a method 500 for eavesdropper detection based on wavelength division multiplexing of quantum and classical signals, according to an example embodiment. By way of example, network node 110 may serve as a sending or transmitting node for communication of data over fiber 442 or other network channel, while node 120 may serve as a receiving node for the communication. However, the communication may occur between any network nodes in substantially the same manner described below.

Initially, sending node 110 desires to transmit a classical data signal (e.g., digital bits representing the data to be transmitted, etc.) to receiving node 120. A random seed is used to generate a random sequence for mixing quantum signals and the classical data signal via wavelength division multiplexing to produce a mixed or hybrid data signal (e.g., of classical and quantum signals, etc.). The random seed is generated by sending node 110, and pre-shared with receiving node 120 via any conventional or other protocols (e.g., quantum key distribution (QKD), post quantum cryptography (PQC), etc.) at operation 505 in substantially the same manner described above. Synchronization logic 440 of sending node 110 and synchronization logic 490 of receiving node 120 synchronize clock 430 of the sending node with clock 480 of the receiving node. In addition, clocks 430, 480 of the sending and receiving nodes are synchronized, where the shared random seed and synchronized clocks enable the sending and receiving nodes to generate the same random sequence for sending and receiving the mixed data signal in a manner to detect eavesdroppers.

Sending node 110 uses the random seed to generate a random sequence including random numbers at operation 510 in substantially the same manner described above. The random numbers indicate wavelengths and are used to mix quantum signals and the classical data signal to produce the mixed data signal for transmission. For example, the random numbers may correspond to wavelengths for the mixed data signal (e.g., wavelengths for wavelength division multiplexing, etc.). By way of example, the random numbers may be within a numeric range with numbers of the range mapped to corresponding wavelengths (e.g., the wavelength may be a multiple of the random number, may be associated with the random number by a listing or mapping, etc.).

Quantum source 405 receives random numbers (or wavelengths) from processor 420 for producing quantum signals, while classical source 410 receives random numbers (or wavelengths) from processor 420 for producing classical data signals. The quantum and classical signals of the various wavelengths are provided to multiplexer 415 that combines the individual wavelengths to form the mixed data signal at operation 515 in substantially the same manner described above. The mixed data signal is sent from sending node 110 to receiving node 120. In other words, sending node 110 randomly selects wavelengths for quantum source 405 and classical source 410 for sending the mixed data signal over fiber 442 to receiving node 120. The quantum signals and classical signals of the mixed data signal are wavelength division multiplexed.

Receiving node 120 uses the random seed to generate the same random sequence including random numbers (or wavelengths) used for transmission of the mixed data signal at operation 520 in substantially the same manner described above. The random numbers indicate the wavelengths for the classical and quantum signals in order to retrieve those signals from the mixed data signal and direct them to the appropriate (quantum or classical) receiver.

De-multiplexer 465 de-multiplexes the mixed data signal into individual wavelengths that are directed to quantum receiver 455 or classical receiver 460 based on the random numbers (or wavelengths) from processor 470 to process the mixed data signal and determine a presence of an eavesdropper at operation 525 in substantially the same manner described above. In this case, receiving node 120 knows the wavelengths of the quantum signals in the mixed data signal based on the random numbers, and actively directs portions of the mixed data signal to quantum receiver 455 and classical receiver 460. By randomizing the wavelengths of the quantum signals, it makes it virtually impossible for an eavesdropper to measure just the classical signal. Accordingly, the eavesdropper measures the quantum signals which affect their state.

Quantum receiver 455 detects and calculates channel statistics by observing loss experienced by the single photons. When an error rate of detection (or loss) is too high (e.g., exceeds a threshold due to the disturbed quantum states produced by an eavesdropper) as determined at operation 530, this indicates the presence of the eavesdropper at operation 535. Receiving node 120 may perform an appropriate action in response to detection of the eavesdropper (e.g., discard the mixed data signal, send communication to the sending node to re-transmit a new mixed data signal (e.g., using a new random number sequence, etc.), etc.).

When the error rate of detection (or loss) is acceptable (e.g., at or below the threshold) as determined at operation 530, this indicates the absence of the eavesdropper (e.g., valid or secure data, etc.) at operation 540. Receiving node 120 may perform an appropriate action in response to the valid or secure data (e.g., process the data, forward the data, etc.).

In an embodiment, a multi-core fiber or bundled multiple fibers may be employed for communication based on space division multiplexing (SDM). This approach is applicable to both multi-core fiber systems and bundled multiple fibers. In this case, synchronized cryptographically secure random number generators (CSRNGs) are used in the sending node and receiving node to select which fiber to use for the quantum signal. The sending node may include a laser source, modulator, and an optical switch for directing the classical and the quantum signals to the appropriate fibers or cores following a random order, where the randomness is based on the output from CSRNG. The receiving node would be dynamic in nature or, in other words, know a priori where the quantum and the classical signals are located based on the CSRNG. The optical switch is used to appropriately send the quantum signal to a quantum receiver and the classical signal to a classical receiver. The quantum receiver may be a low bandwidth homodyne/heterodyne receiver and the classical receiver may be a conventional receiver. The optical switch may be a Micro-Electro-Mechanical Systems (MEMS) or piezoelectric based optical switch. MEMS was used for illustration purposes.

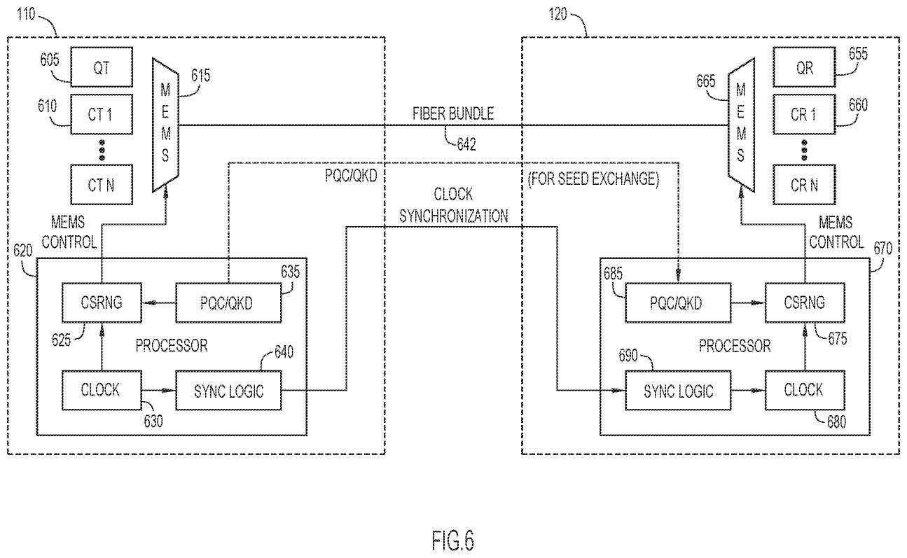

With continued reference to FIG. 1, FIG. 6 illustrates a block diagram of network nodes implementing eavesdropper detection based on space division multiplexing of quantum and classical signals, according to an example embodiment. In an embodiment, the classical and quantum signals can be multiplexed using space division multiplexing. By way of example, network node 110 may serve as a sending or transmitting node for communication of data over fiber bundle 642 or other network channel, while network node 120 may serve as a receiving node for the communication. Fiber bundle 642 may include a multi-core fiber or bundled multiple fibers. However, the communication may occur between any nodes in substantially the same manner described below. Sending node 110 and receiving node 120 share a randomness source which allow them to synchronize the encoding/decoding. In order to synchronize the randomness between sending node 110 and receiving node 120, they can securely share a seed. Using a pseudo-random number generator, they can produce a high rate of correlated random locations (or fibers) to place the quantum signals. By randomizing the location (or fiber) of the quantum signals, it makes it virtually impossible for an eavesdropper to measure just the classical signal. Accordingly, the eavesdropper measures the quantum signals which affect their state.

Receiving node 120, knowing the fibers of the quantum signals, directs the quantum signals from those fibers to a quantum receiver or detector. When the error rate of detection is too high (due to the disturbed quantum states), this indicates the presence of the eavesdropper and appropriate action may be performed (e.g., discarding the data signal, re-transmitting a new mixed data signal, etc.).

Initially, sending node 110 includes a quantum transmitter 605, one or more classical transmitters 610 each transmitting a portion of a classical data signal, a Micro-Electro-Mechanical Systems (MEMS) based switch 615, and a processor 620. These may be in a network interface, and may be implemented by any conventional or other components for performing operations of a present embodiment. For example, the quantum and classical transmitters may include any conventional or other laser source and modulator.

Receiving node 120 includes a quantum receiver 655, one or more classical receivers 660, a Micro-Electro-Mechanical Systems (MEMS) based switch 665, and a processor 670. These may be in a network interface, and may be implemented by any conventional or other components for performing operations of a present embodiment. For example, the quantum receiver may include any conventional or other low bandwidth homodyne/heterodyne receiver, and the classical receivers may include any conventional or other receivers.

Processor 620 of sending node 110 includes a cryptographically secure random number generator (CSRNG) 625, a clock 630, an exchange module 635, and synchronization logic 640. These may be implemented by any conventional or other components for performing operations of a present embodiment, and may be substantially similar to corresponding components described above (FIGS. 2 and 4). Processor 670 of receiving node 120 includes a cryptographically secure random number generator (CSRNG) 675, a clock 680, an exchange module 685, and synchronization logic 690. These may be implemented by any conventional or other components for performing operations of a present embodiment, and may be substantially similar to corresponding components described above (FIGS. 2 and 4).

Initially, sending node 110 desires to transmit a classical data signal (e.g., digital bits representing the data to be transmitted, etc.) to receiving node 120. A random seed is used to generate a random sequence for mixing quantum signals and the classical data signal via space division multiplexing to produce a mixed or hybrid data signal (e.g., of classical and quantum signals, etc.). The random seed may be generated by exchange module 635 of sending node 110 via any conventional or other techniques, and pre-shared by exchange module 635 of the sending node and exchange module 685 of receiving node 120 via any conventional or other protocols (e.g., quantum key distribution (QKD), post quantum cryptography (PQC), etc.). Synchronization logic 640 of sending node 110 and synchronization logic 690 of receiving node 120 synchronize clock 630 of the sending node with clock 680 of the receiving node. Synchronization logic 640, 690 of the sending and receiving nodes are coupled to respective clocks 630, 680, and may use any conventional or other techniques to synchronize clocks 630, 680. The shared random seed and synchronized clocks enable the sending and receiving nodes to generate the same random sequence for sending and receiving the mixed data signal in a manner to detect eavesdroppers.

Cryptographically secure random number generator 625 of sending node 110 receives the random seed from exchange module 635, and uses the random seed to generate a random sequence including random numbers under control of signals from clock 630. The random numbers are used to mix quantum signals and the classical data signal to produce the mixed data signal for transmission. For example, the random numbers may correspond to fibers for the mixed data signal (e.g., fibers for the space division multiplexing, etc.). By way of example, the random numbers may be within a numeric range with numbers of the range mapped to corresponding fibers (e.g., the fibers may be associated with the random number by a listing or mapping, may have identifiers that correspond to the random numbers, etc.).

Processor 620 of sending node 110 is coupled to Micro-Electro-Mechanical Systems (MEMS) based switch 615 (e.g., or other switching device, etc.). The switch directs the classical and the quantum signals to the appropriate fiber following a random order based on control signals from processor 620 to mix the quantum signals and the classical data signal to produce the mixed data signal for transmission. The random numbers produced by cryptographically secure random number generator 625 are provided to MEMS based switch 615 at appropriate times based on signals from clock 630, and serve as controls to select the fibers for the classical and quantum signals of the mixed data signal based on the random numbers. The resulting mixed data signal is sent from sending node 110 to receiving node 120 over the selected fibers of fiber bundle 642. In other words, sending node 110 actively switches (via MEMS switch 615) fibers for quantum transmitter 605 and classical transmitters 610 for sending the mixed data signal over fiber bundle 642 to receiving node 120. The quantum signals and classical signals of the mixed data signal are space division multiplexed.

Cryptographically secure random number generator 675 of receiving node 120 receives the random seed from exchange module 685, and uses the random seed to generate the same random sequence including random numbers used for transmission of the mixed data signal under control of signals from clock 680. The random number sequence is used to retrieve the classical and quantum signals from the mixed data signal. For example, the random numbers may correspond to fibers for the mixed data signal (e.g., fibers for the space division multiplexing, etc.). By way of example, the random numbers may be within a numeric range with numbers of the range mapped to corresponding fibers (e.g., the fibers may be associated with the random number by a listing or mapping, may have identifiers that correspond to the random numbers, etc.).

Processor 670 of receiving node 120 is coupled to Micro-Electro-Mechanical Systems (MEMS) based switch 665 (e.g., or other switching device, etc.). The MEMS based switch directs or routes signals from the mixed data signal to quantum receiver 655 or classical receiver 660 based on control signals from processor 670 to process the mixed data signal and determine a presence of an eavesdropper. The random number sequence produced by cryptographically secure random number generator 675 is provided to MEMS based switch 665 at appropriate times based on signals from clock 680, and serves as controls to direct the classical and quantum signals of the mixed data signal from the appropriate fibers of fiber bundle 642 to quantum receiver 655 or classical receiver 660 based on the random number sequence (e.g., indicating fibers for the classical and quantum signals).

In this case, receiving node 120 knows the locations (or fibers) of the quantum signal in the mixed data signal based on the random number sequence, and actively directs (via Micro-Electro-Mechanical Systems (MEMS) based switch 665) quantum and classical portions of the mixed data signal from the fibers to the appropriate quantum receiver 655 and classical receiver 660. By randomizing the location of the quantum signals, it makes it virtually impossible for an eavesdropper to measure just the classical signal. Accordingly, the eavesdropper measures the quantum signals which affect their state. When the error rate of detection is too high (due to the disturbed quantum states), this indicates the presence of the eavesdropper and the receiving node may perform appropriate action (e.g., discard the mixed data signal, send communication to the sending node to re-transmit a new mixed data signal (e.g., using a new random number sequence, etc.), etc.).

Thus, synchronized cryptographically secure random number generators (CSRNGs) enable spatial multiplexing via multicore fibers or bundled single fibers and use of Micro-Electro-Mechanical Systems (MEMS) or piezoelectric based switches. Since a MEMS based switch is usually at a kilohertz (kHz) level, increased quantum channels may be used for improved detection of the eavesdropper.

The space division multiplexing approach of an embodiment is based on the use of multicore fiber or bundled fibers. Multicore fiber may be preferred in certain situations since a fiber bundle usually has a larger physical dimension which may restrict capacity for a limited physical space. Fiber bundles may be preferred in certain situations where the cost, maintenance and repair of multicore fiber are of concern.

Further, updating of the (random seed for the) cryptographically secure random number generators (CSRNGs) in the sending and receiving nodes are synchronized. The CSRNGs are updated concurrently to maintain the correct configuration of quantum and classical signal fibers. The synchronization may use any conventional or other protocols (e.g., Precision Time Protocol, Synchronous Ethernet, etc.). The time or time intervals at which the CSRNGs are concurrently updated (with new random seeds) may be randomized via the use of another CSRNG or by processing the output of the same CSRNG. This would introduce further randomization into the fiber configuration, making it harder for an eavesdropper to listen if they were somehow taking advantage of the periodic nature of the fiber configuration changes.

The space division multiplexing approach of an embodiment provides eavesdropper monitoring capability for a larger time period without sacrificing the bandwidth of classical communication. Space division multiplexing has less requirements on a quantum source and detection. A regular attenuated coherent state, single wavelength without involving tunability, with homodyne detection is sufficient. Meanwhile, the use of a single-mode fiber bundle is also less complicated. Considering a single-mode fiber bundle is a common technique to increase the communication link capacity, the space division multiplexing approach of the embodiment is more compatible with the current fiber communication infrastructure.

Since the classical signal and quantum signal are physically separated, there is no concern regarding the noise in quantum signal induced by classical counterparts. The security enhancement comes from the property that, since the quantum signal is randomly switching between different fibers or cores, the spatial interspersing of the quantum signals will result in a random attack from an eavesdropper tapping all signals, and the tapping of the quantum signal would be easier to detect. The level of security can be adjusted by adding more quantum channels.

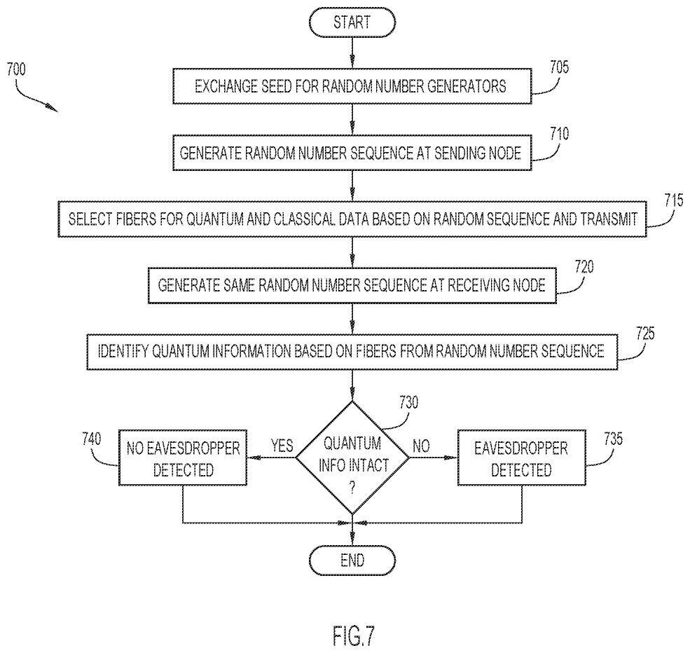

With continued reference to FIGS. 1 and 6, FIG. 7 illustrates a flowchart of a method 700 for eavesdropper detection based on space division multiplexing of quantum and classical signals, according to an example embodiment. By way of example, network node 110 may serve as a sending or transmitting node for communication of data over fiber bundle 642 or other network channel, while node 120 may serve as a receiving node for the communication. However, the communication may occur between any network nodes in substantially the same manner described below.

Initially, sending node 110 desires to transmit a classical data signal (e.g., digital bits representing the data to be transmitted, etc.) to receiving node 120. A random seed is used to generate a random sequence for mixing quantum signals and the classical data signal via space division multiplexing to produce a mixed or hybrid data signal (e.g., of classical and quantum signals, etc.). The random seed is generated by sending node 110, and pre-shared with receiving node 120 via any conventional or other protocols (e.g., quantum key distribution (QKD), post quantum cryptography (PQC), etc.) at operation 705 in substantially the same manner described above. Synchronization logic 640 of sending node 110 and synchronization logic 690 of receiving node 120 synchronize clock 630 of the sending node with clock 680 of the receiving node. In addition, clocks 630, 680 of the sending and receiving nodes are synchronized, where the shared random seed and synchronized clocks enable the sending and receiving nodes to generate the same random number sequence for sending and receiving the mixed data signal in a manner to detect eavesdroppers.

Sending node 110 uses the random seed to generate a random sequence including random numbers at operation 710 in substantially the same manner described above. The random numbers are used to mix quantum signals and the classical data signal to produce the mixed data signal for transmission. For example, the random numbers may correspond to fibers for the mixed data signal (e.g., fibers for the space division multiplexing, etc.). By way of example, the random numbers may be within a numeric range with numbers of the range mapped to corresponding fibers (e.g., the fibers may be associated with the random number by a listing or mapping, may have identifiers that correspond to the random numbers, etc.).

Micro-Electro-Mechanical Systems (MEMS) based switch 615 of sending node 110 directs the classical and the quantum signals to the appropriate fiber following a random order based on the random numbers at operation 715 in substantially the same manner described above. The resulting mixed data signal is sent from sending node 110 to receiving node 120. In other words, sending node 110 actively switches (via MEMS switch 615) fibers for quantum transmitter 605 and classical transmitters 610 for sending the mixed data signal over fiber bundle 642 to receiving node 120. The quantum signals and classical signals of the mixed data signal are space division multiplexed.

Receiving node 120 uses the shared random seed to generate the same random sequence including random numbers used for transmission of the mixed data signal at operation 720 in substantially the same manner described above. The random number sequence is used to retrieve the classical and quantum signals of the mixed data signal from the appropriate fibers of fiber bundle 642. For example, the random numbers may correspond to fibers for the mixed data signal (e.g., fibers for the space division multiplexing, etc.). By way of example, the random numbers may be within a numeric range with numbers of the range mapped to corresponding fibers (e.g., the fibers may be associated with the random number by a listing or mapping, may have identifiers that correspond to the random numbers, etc.).

Micro-Electro-Mechanical Systems (MEMS) based switch 665 of receiving node 120 directs or routes signals of the mixed data signal from appropriate fibers of fiber bundle 642 to quantum receiver 655 and classical receivers 660 based on the random numbers at operation 725 in substantially the same manner described above. In this case, receiving node 120 knows the locations (fibers) of the quantum signal in the mixed data signal based on the random numbers, and actively directs (via MEMS based switch 665) portions of the mixed data signal from appropriate fibers of fiber bundle 642 to quantum receiver 655 and classical receivers 660. By randomizing the location (fibers) of the quantum signals, it makes it virtually impossible for an eavesdropper to measure just the classical signal. Accordingly, the eavesdropper measures the quantum signals which affect their state.

The quantum signals are analyzed, and when an error rate of detection is too high (e.g., exceeds a threshold due to the disturbed quantum states produced by an eavesdropper) as determined at operation 730, this indicates the presence of the eavesdropper at operation 735. Receiving node 120 may perform an appropriate action in response to detection of the eavesdropper (e.g., discard the mixed data signal, send communication to the sending node to re-transmit a new mixed data signal (e.g., using a new random number sequence, etc.), etc.).

When the error rate of detection is acceptable (e.g., at or below the threshold) as determined at operation 730, this indicates the absence of the eavesdropper (e.g., valid or secure data, etc.) at operation 740. Receiving node 120 may perform an appropriate action in response to the valid or secure data (e.g., process the data, forward the data, etc.).

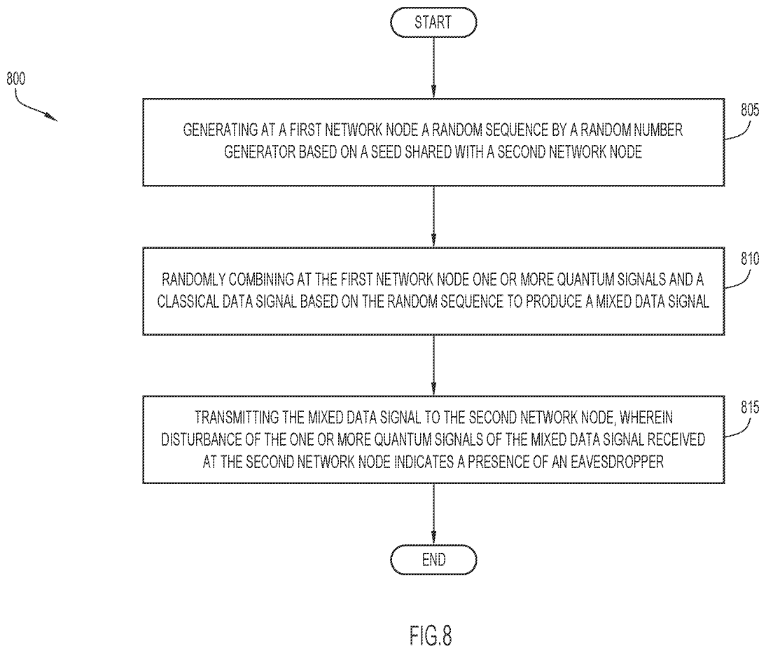

FIG. 8 illustrates a flowchart of an example method 800 for eavesdropper detection, according to an example embodiment. At operation 805, a first network node generates a random sequence by a random number generator based on a seed shared with a second network node. At operation 810, the first network node randomly combines one or more quantum signals and a classical data signal based on the random sequence to produce a mixed data signal. At operation 815, the mixed data signal is transmitted to the second network node. Disturbance of the one or more quantum signals of the mixed data signal received at the second network node indicates a presence of an eavesdropper.

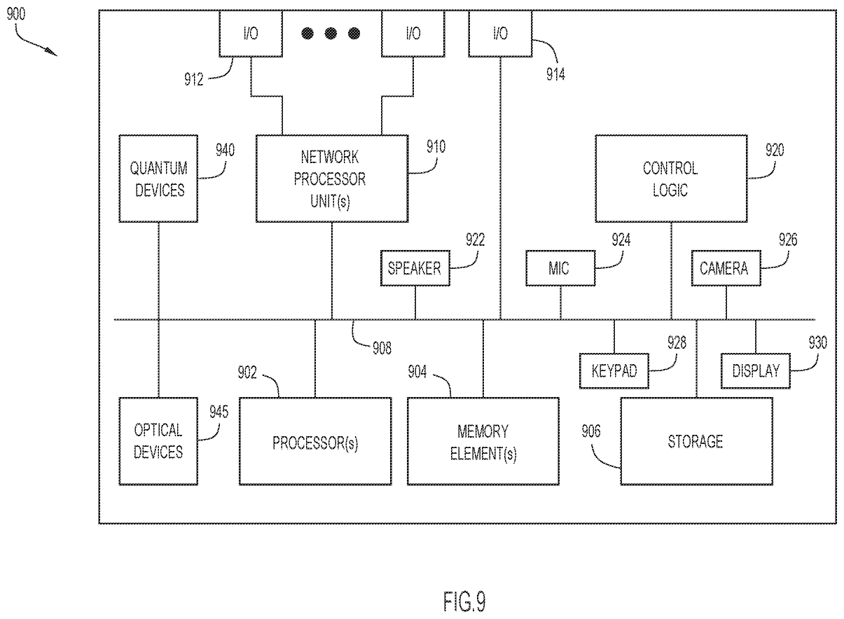

Referring to FIG. 9, FIG. 9 illustrates a hardware block diagram of a computing device 900 that may perform functions associated with operations discussed herein in connection with the techniques depicted in FIGS. 1-8. In various embodiments, a computing device or apparatus or system, such as computing device 900 or any combination of computing devices 900, may be configured as any device entity/entities (e.g., nodes, computer devices, user devices, client devices, communication devices, network devices, processors, switching devices, network interfaces, etc.) as discussed for the techniques depicted in connection with FIGS. 1-8 in order to perform operations of the various techniques discussed herein.

In at least one embodiment, computing device 900 may be any apparatus that may include one or more processor(s) 902, one or more memory element(s) 904, storage 906, a bus 908, one or more network processor unit(s) 910 interconnected with one or more network input/output (I/O) interface(s) 912, one or more I/O interface(s) 914, and control logic 920. In various embodiments, instructions associated with logic for computing device 900 can overlap in any manner and are not limited to the specific allocation of instructions and/or operations described herein.

In at least one embodiment, processor(s) 902 is/are at least one hardware processor configured to execute various tasks, operations and/or functions for computing device 900 as described herein according to software and/or instructions configured for computing device 900. Processor(s) 902 (e.g., a hardware processor) can execute any type of instructions associated with data to achieve the operations detailed herein. In one example, processor(s) 902 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 904 and/or storage 906 is/are configured to store data, information, software, and/or instructions associated with computing device 900, and/or logic configured for memory element(s) 904 and/or storage 906. For example, any logic described herein (e.g., control logic 920) can, in various embodiments, be stored for computing device 900 using any combination of memory element(s) 904 and/or storage 906. Note that in some embodiments, storage 906 can be consolidated with memory elements 904 (or vice versa), or can overlap/exist in any other suitable manner.

In at least one embodiment, bus 908 can be configured as an interface that enables one or more elements of computing device 900 to communicate in order to exchange information and/or data. Bus 908 can be implemented with any architecture designed for passing control, data and/or information between processors, memory elements/storage, peripheral devices, and/or any other hardware and/or software components that may be configured for computing device 900. In at least one embodiment, bus 908 may be implemented as a fast kernel-hosted interconnect, potentially using shared memory between processes (e.g., logic), which can enable efficient communication paths between the processes.

In various embodiments, network processor unit(s) 910 may enable communication between computing device 900 and other systems, entities, etc., via network I/O interface(s) 912 to facilitate operations discussed for various embodiments described herein. In various embodiments, network processor unit(s) 910 can be configured as a combination of hardware and/or software, such as one or more Ethernet driver(s) and/or controller(s) or interface cards, Fibre Channel (e.g., driver(s) optical) and/or controller(s), wireless receivers/transmitters/transceivers, baseband processor(s)/modem(s), and/or other similar network interface driver(s) and/or controller(s) now known or hereafter developed to enable communications between computing device 900 and other systems, entities, etc. to facilitate operations for various embodiments described herein. In various embodiments, network I/O interface(s) 912 can be configured as one or more Ethernet port(s), Fibre Channel ports, any other I/O port(s), and/or antenna(s)/antenna array(s) now known or hereafter developed. Thus, the network processor unit(s) 910 and/or network I/O interfaces 912 may include suitable interfaces for receiving, transmitting, and/or otherwise communicating data and/or information in a network environment.

I/O interface(s) 914 allow for input and output of data and/or information with other entities that may be connected to computing device 900. For example, I/O interface(s) 914 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

With respect to certain entities (e.g., client device, network device, nodes, processors, network interfaces, switching devices, etc.), computing device 900 may further include, or be coupled to, a speaker 922 to convey sound, microphone or other sound sensing device 924, camera or image capture device 926, a keypad or keyboard 928 to enter information (e.g., alphanumeric information, etc.), a touch screen or other display 930, quantum devices 940, and/or optical devices 945. These items may be coupled to bus 908 or I/O interface(s) 914 to transfer data with other elements of computing device 900. Quantum devices 940 may include any conventional or other devices to perform the functions described herein (e.g., generating, transmitting, receiving, entangling, and/or processing quantum signals), such as a quantum source, quantum transmitters and receivers, quantum channels, a source of randomness, lasers or other energy sources, quantum measuring devices, quantum logic or other gates or circuits, quantum memories, quantum processors, quantum buffers, etc. Optical devices 945 may include any conventional or other optical devices to perform the functions described herein (e.g., generating, transmitting, receiving, and/or processing classical or other optical signals), such as optical switches, optical transmitters and receivers, optical multiplexers or other switching devices, etc.

In various embodiments, control logic 920 can include instructions that, when executed, cause processor(s) 902 to perform operations, which can include, but not be limited to, providing overall control operations of computing device 900; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 920) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

Data relating to operations described herein may be stored within any conventional or other data structures (e.g., files, arrays, lists, stacks, queues, records, etc.) and may be stored in any desired storage unit (e.g., database, data or other stores or repositories, queue, etc.). The data transmitted between device entities may include any desired format and arrangement, and may include any quantity of any types of fields of any size to store the data. The definition and data model for any datasets may indicate the overall structure in any desired fashion (e.g., computer-related languages, graphical representation, listing, etc.).

The present embodiments may employ any number of any type of user interface (e.g., graphical user interface (GUI), command-line, prompt, etc.) for obtaining or providing information, where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The environment of the present embodiments may include any number of computer or other processing systems (e.g., client or end-user systems, server systems, network devices, storage devices, etc.) and databases or other repositories arranged in any desired fashion, where the present embodiments may be applied to any desired type of computing environment (e.g., cloud computing, client-server, network computing, mainframe, stand-alone systems, datacenters, etc.). The computer or other processing systems employed by the present embodiments may be implemented by any number of any personal or other type of computer or processing system (e.g., desktop, laptop, Personal Digital Assistant (PDA), mobile devices, etc.), and may include any commercially available operating system and any combination of commercially available and custom software. These systems may include any types of monitors and input devices (e.g., keyboard, mouse, voice recognition, etc.) to enter and/or view information.

It is to be understood that the software of the present embodiments may be implemented in any desired computer language and could be developed by one of ordinary skill in the computer arts based on the functional descriptions contained in the specification and flowcharts and diagrams illustrated in the drawings. Further, any references herein of software performing various functions generally refer to computer systems or processors performing those functions under software control. The computer systems of the present embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., Local Area Network (LAN), Wide Area Network (WAN), Intranet, Internet, hardwire, modem connection, wireless, etc.). For example, the functions of the present embodiments may be distributed in any manner among the various network devices, storage devices, and other processing devices or systems, and/or any other intermediary processing devices. The software and/or algorithms described above and illustrated in the flowcharts and diagrams may be modified in any manner that accomplishes the functions described herein. In addition, the functions in the flowcharts, diagrams, or description may be performed in any order that accomplishes a desired operation.

The networks of present embodiments may be implemented by any number of any type of communications network (e.g., LAN, WAN, Internet, Intranet, Virtual Private Network (VPN), etc.). The computer or other processing systems of the present embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., LAN, hardwire, wireless link, Intranet, etc.).

Each of the elements described herein may couple to and/or interact with one another through interfaces and/or through any other suitable connection (wired or wireless) that provides a viable pathway for communications. Interconnections, interfaces, and variations thereof discussed herein may be utilized to provide connections among elements in a system and/or may be utilized to provide communications, interactions, operations, etc. among elements that may be directly or indirectly connected in the system. Any combination of interfaces can be provided for elements described herein in order to facilitate operations as discussed for various embodiments described herein.

In various embodiments, any device entity or apparatus as described herein may store data/information in any suitable volatile and/or non-volatile memory item (e.g., magnetic hard disk drive, solid state hard drive, semiconductor storage device, Random Access Memory (RAM), Read Only Memory (ROM), Erasable Programmable ROM (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more device entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, Digital Signal Processing (DSP) instructions, software [potentially inclusive of object code and source code], etc.) for execution by one or more processor(s), and/or other similar machine, etc. Generally, memory element(s) 904 and/or storage 906 can store data, software, code, instructions (e.g., processor instructions), logic, parameters, combinations thereof, and/or the like used for operations described herein. This includes memory elements 904 and/or storage 906 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, Compact Disc ROM (CD-ROM), Digital Versatile Disc (DVD), memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any Local Area Network (LAN), Virtual LAN (VLAN), Wide Area Network (WAN) (e.g., the Internet), Software Defined WAN (SD-WAN), Wireless Local Area (WLA) access network, Wireless Wide Area (WWA) access network, Metropolitan Area Network (MAN), Intranet, Extranet, Virtual Private Network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may be directly or indirectly connected utilizing any algorithms, communication protocols, interfaces, etc. (proprietary and/or non-proprietary) that allow for the exchange of data and/or information.

In various example implementations, any device entity or apparatus for various embodiments described herein can encompass network elements (which can include virtualized network elements, functions, etc.) such as, for example, network appliances, forwarders, routers, servers, switches, gateways, bridges, load-balancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four device entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ or ‘frame’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more device entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combinations of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

In one form, a method is provided. The method comprises: generating at a first network node a random sequence by a random number generator based on a seed shared with a second network node; randomly combining at the first network node one or more quantum signals and a classical data signal based on the random sequence to produce a mixed data signal; and transmitting the mixed data signal to the second network node, wherein disturbance of the one or more quantum signals of the mixed data signal received at the second network node indicates a presence of an eavesdropper.

In one example, the one or more quantum signals are combined with the classical data signal using time division multiplexing and the random sequence indicates times for combining the one or more quantum signals with the classical data signal.

In one example, the one or more quantum signals are combined with the classical data signal using wavelength division multiplexing and the random sequence indicates wavelengths for the one or more quantum signals and the classical data signal.

In one example, the one or more quantum signals are combined with the classical data signal using space division multiplexing and the random sequence indicates fibers from among a plurality of fibers for the one or more quantum signals and the classical data signal.

In one example, the one or more quantum signals are combined with the classical data signal using decoy states and the random sequence indicates intensities for the one or more quantum signals and the classical data signal.

In one example, the method further comprises synchronizing updates of the random sequence between the first network node and the second network node.

In one example, the method further comprises updating the random sequence at the first network node at random time intervals.

In one example, the method further comprises: receiving the mixed data signal at the second network node; generating a same random sequence at the second network node based on the seed shared with the first network node; retrieving the one or more quantum signals from the mixed data signal at the second network node based on the same random sequence; and determining the presence of the eavesdropper based on disturbance of the one or more quantum signals.

In another form, an apparatus is provided. The apparatus comprises a first network node having a network interface coupled to one or more processors. The one or more processors are configured to: generate a random sequence by a random number generator based on a seed shared with a second network node; randomly combine, via a switching device, one or more quantum signals and a classical data signal based on the random sequence to produce a mixed data signal; and transmit the mixed data signal to the second network node, wherein disturbance of the one or more quantum signals of the mixed data signal received at the second network node indicates a presence of an eavesdropper.

In another form, an apparatus is provided. The apparatus comprises a first network node having a network interface coupled to one or more processors. The one or more processors are configured to: receive a mixed data signal from a second network node including one or more quantum signals randomly combined with a classical data signal based on a random sequence generated via a seed shared with the first network node; generate a same random sequence based on the seed shared with the second network node; retrieve the one or more quantum signals from the mixed data signal, via a switching device, based on the same random sequence; and determine a presence of an eavesdropper based on disturbance of the one or more quantum signals.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method comprising:
generating at a first network node a random sequence by a random number generator based on a seed shared with a second network node;
randomly combining at the first network node one or more quantum signals and a classical data signal based on the random sequence to produce a mixed data signal; and
transmitting the mixed data signal to the second network node, wherein disturbance of the one or more quantum signals of the mixed data signal received at the second network node indicates a presence of an eavesdropper.

2. The method of claim 1, wherein the one or more quantum signals are combined with the classical data signal using time division multiplexing and the random sequence indicates times for combining the one or more quantum signals with the classical data signal.

3. The method of claim 1, wherein the one or more quantum signals are combined with the classical data signal using wavelength division multiplexing and the random sequence indicates wavelengths for the one or more quantum signals and the classical data signal.

4. The method of claim 1, wherein the one or more quantum signals are combined with the classical data signal using space division multiplexing and the random sequence indicates fibers from among a plurality of fibers for the one or more quantum signals and the classical data signal.

5. The method of claim 1, wherein the one or more quantum signals are combined with the classical data signal using decoy states and the random sequence indicates intensities for the one or more quantum signals and the classical data signal.

6. The method of claim 1, further comprising:
synchronizing updates of the random sequence between the first network node and the second network node.

7. The method of claim 1, further comprising:
updating the random sequence at the first network node at random time intervals.

8. The method of claim 1, further comprising:
receiving the mixed data signal at the second network node;
generating a same random sequence at the second network node based on the seed shared with the first network node;
retrieving the one or more quantum signals from the mixed data signal at the second network node based on the same random sequence; and
determining the presence of the eavesdropper based on disturbance of the one or more quantum signals.

9. An apparatus comprising:
a first network node having a network interface coupled to one or more processors, wherein the one or more processors are configured to:
generate a random sequence by a random number generator based on a seed shared with a second network node;
randomly combine, via a switching device, one or more quantum signals and a classical data signal based on the random sequence to produce a mixed data signal; and
transmit the mixed data signal to the second network node, wherein disturbance of the one or more quantum signals of the mixed data signal received at the second network node indicates a presence of an eavesdropper.

10. The apparatus of claim 9, wherein the one or more quantum signals are combined with the classical data signal using time division multiplexing and the random sequence indicates times for combining the one or more quantum signals with the classical data signal.

11. The apparatus of claim 9, wherein the one or more quantum signals are combined with the classical data signal using wavelength division multiplexing and the random sequence indicates wavelengths for the one or more quantum signals and the classical data signal.

12. The apparatus of claim 9, wherein the one or more quantum signals are combined with the classical data signal using space division multiplexing and the random sequence indicates fibers from among a plurality of fibers for the one or more quantum signals and the classical data signal.

13. The apparatus of claim 9, wherein the one or more processors are further configured to:
synchronize updates of the random sequence between the first network node and the second network node.

14. The apparatus of claim 9, wherein the one or more processors are further configured to:
update the random sequence at the first network node at random time intervals.

15. An apparatus comprising:
a first network node having a network interface coupled to one or more processors, wherein the one or more processors are configured to:
receive a mixed data signal from a second network node including one or more quantum signals randomly combined with a classical data signal based on a random sequence generated via a seed shared with the first network node;
generate a same random sequence based on the seed shared with the second network node;
retrieve the one or more quantum signals from the mixed data signal, via a switching device, based on the same random sequence; and
determine a presence of an eavesdropper based on disturbance of the one or more quantum signals.

16. The apparatus of claim 15, wherein the mixed data signal includes the one or more quantum signals combined with the classical data signal using time division multiplexing and the random sequence indicates times for combining the one or more quantum signals with the classical data signal.

17. The apparatus of claim 15, wherein the mixed data signal includes the one or more quantum signals combined with the classical data signal using wavelength division multiplexing and the random sequence indicates wavelengths for the one or more quantum signals and the classical data signal.

18. The apparatus of claim 15, wherein the mixed data signal includes the one or more quantum signals combined with the classical data signal using space division multiplexing and the random sequence indicates fibers from among a plurality of fibers for the one or more quantum signals and the classical data signal.

19. The apparatus of claim 15, wherein the one or more processors are further configured to:
synchronize updates of the random sequence between the first network node and the second network node.

20. The apparatus of claim 15, wherein the one or more processors are further configured to:
update the random sequence at random time intervals.
